(19) United States
(12) Patent Application Publication
(10) Pub. No.: US 2022/0327469 A1
(43) Pub. Date: Oct. 13, 2022

(54) Information Processing Method for Item in Distribution System and Electronic Device

(71) Applicant: Coupang Corp., Seoul (KR)

(72) Inventor: Byoung Yong Park, Seoul (KR)

(73) Assignee: Coupang Corp., Seoul (KR)

(21) Appl. No.: 17/382,609

(22) Filed: Jul. 22, 2021

(30) Foreign Application Priority Data
Apr. 9, 2021 (KR) 10-2021-0046408

(51) Int. Cl. G06Q 10/08; G06Q 30/06

(52) U.S. Cl. CPC G06Q 10/087; G06Q 30/0623; G06Q 30/0633; G06Q 30/0283

(57) ABSTRACT

Information processing method includes confirming a specific item and a fulfillment center based on a user input, acquiring first purchase price information and first quantity information related to the specific item put into the fulfillment center based on first purchase information, confirming second purchase price information and second quantity information related to the specific item when corresponding to a preset event, generating carry out information related to the specific item based on the first purchase price information and the first quantity information, and generating second purchase information related to the specific item based on the second purchase price information and the second quantity information, in which the preset event occurs in response to a discrepancy between purchase quantity information corresponding to the first purchase information and the first quantity information, and the second quantity information is determined by a difference between the purchase quantity information and the first quantity information.

### TECHNICAL FIELD

Example embodiments of the present disclosure relate to an information processing method for an item in a distribution system and an electronic device.

### DESCRIPTION OF THE RELATED ART

Items put and managed into a fulfillment center may include items that are directly purchased to a supplier and are managed. A process of putting items into individual fulfillment centers, placing orders for each supplier, and carrying out items from the fulfillment centers to the suppliers are performed in the distribution system that oversees sales of the items according to a change in quantity, purchase price, and sales price of the items.

A system that oversees sales of items and electronic devices that constitute the system may issue VAT invoices or receipts between fulfillment centers and suppliers. Payments for warehousing, ordering, and carrying out of items may be frequently performed according to a change in contract details. In the case where purchase prices of items warehoused are changed due to the missing count for a quantity of the items warehoused or the change in sales prices of the items warehoused, when virtual VAT invoices or receipts are issued for the omitted or changed items, errors are reduced due to the carrying out and purchase, so items that are directly purchased and managed may be effectively managed.

As the related document that may be referred to, there is Korean Patent Publication No. 10-2011-0044095. The related document discloses features related to radio tags that store order information attached to items but does not disclose processing information to be included in virtual VAT invoices or receipts due to a change in information on items according to a change in contract of delivery for the items or a missing count for a quantity of items warehoused. Accordingly, a method and apparatus for solving such issues may be required.

### DISCLOSURE OF THE INVENTION

VAT invoices or receipts for items that are put into fulfillment centers through suppliers having concluded a supply contract for items and sold need to be changed entirely due to the partial change in the supply contract for the items or a missing count for the quantity of the items warehoused. Therefore, there may be a hassle in the system.

An aspect provides a method and device for efficiently processing information by generating a virtual VAT invoice or receipt according to information on carrying out and purchase of an item based on a change in purchase contract with a supplier for an item put into a fulfillment center or a quantity of items counted in the fulfillment center, and issuing a VAT invoice or a receipt based on information finally collected afterward.

According to an aspect, there is provided an information processing method for an item in a distribution system, which includes confirming a specific item and a fulfillment center based on a user input, acquiring first purchase price information and first quantity information related to the specific item put into the fulfillment center based on first purchase information, confirming second purchase price information and second quantity information related to the specific item when a preset event occurs, generating carry out information related to the specific item based on the first purchase price information and the first quantity information, and generating second purchase information related to the specific item based on the second purchase price information and the second quantity information, in which the preset event occurs in response to a discrepancy between purchase quantity information corresponding to the first purchase information and the first quantity information, and the second quantity information may be determined by a difference between the purchase quantity information and the first quantity information.

According to another aspect, there is provided an electronic device for a distribution system, which includes a processor that performs confirming a specific item and a fulfillment center based on a user input, acquiring first purchase price information and first quantity information related to the specific item put into the fulfillment center based on first purchase information, confirming second purchase price information and second quantity information related to the specific item when a preset event occurs, generating carry out information related to the specific item based on the first purchase price information and the first quantity information; and generating second purchase information related to the specific item based on the second purchase price information and the second quantity information, in which the preset event occurs in response to a discrepancy between purchase quantity information corresponding to the first purchase information and the first quantity information, and the second quantity information may be determined by a difference between the purchase quantity information and the first quantity information.

According to still another aspect, there is provided a non-transitory computer-readable storage medium including a medium configured to store computer-readable instructions, in which, when the computer-readable instructions are executed by a processor, the processor performs confirming a specific item and a fulfillment center based on a user input, acquiring first purchase price information and first quantity information related to the specific item put into the fulfillment center based on first purchase information, confirming second purchase price information and second quantity information related to the specific item when a preset event occurs, generating carry out information related to the specific item based on the first purchase price information and the first quantity information; and generating second purchase information related to the specific item based on the second purchase price information and the second quantity information, in which the preset event occurs in response to a discrepancy between purchase quantity information corresponding to the first purchase information and the first quantity information, and the second quantity information may be determined by a difference between the purchase quantity information and the first quantity information.

According to various example embodiments of the present disclosure, an information processing method may reduce a cumbersome process by efficiently processing a change in purchase information or some errors of a purchase process in managing a VAT invoice or a receipt for an item directly purchased and sold.

According to various example embodiments of the present disclosure, an electronic device may effectively manage directly purchased and sold items by finally collecting and managing changes in a delivery contract for the directly purchased and sold items through carry out information and purchase information to prevent an overload of information processing that occurs in processing an intermediate process, in which the carrying out and purchase are performed, for correction of errors.

### BRIEF DESCRIPTION OF THE DRAWINGS

FIG. 1 is a block diagram illustrating components of an electronic device according to various example embodiments of the present disclosure.

FIG. 2 is a schematic flowchart of an information processing method according to various example embodiments of the present disclosure.

FIG. 3 is a flowchart illustrating whether a preset event corresponding to a specific item occurs according to various example embodiments of the present disclosure.

FIG. 4 is a flowchart illustrating whether the preset event corresponding to the specific item occurs according to various example embodiments of the present disclosure.

FIG. 5 is an exemplary diagram of information on a specific item managed by an information processing method according to various example embodiments of the present disclosure.

FIG. 6 is a flowchart related to information processing of an electronic device that performs an information processing method according to various example embodiments of the present disclosure.

### DETAILED DESCRIPTION OF THE INVENTION

General terms that are currently widely used are selected as terms used in example embodiments in consideration of functions in the present disclosure but may be changed depending on the intention of those skilled in the art or a judicial precedent, the emergence of a new technique, and the like. In addition, in specific cases, there may be terms arbitrarily chosen by the applicant. In this case, the meaning of such a term will be described in detail in a corresponding description portion. Therefore, the terms used in the present disclosure should be defined on the basis of the meanings of the terms and the content throughout the present disclosure rather than the simple names of the terms.

Throughout the specification, unless otherwise designated, “including” any component means that other components may be further included rather than excluding other components. In addition, the terms “unit,” “module,” and the like described in the specification refer to a processing unit of at least one function or operation and may be implemented by hardware or software or a combination of hardware and software.

The expression “at least one of a, b, and c” described throughout the specification may include “a alone,” “b alone,” “c alone,” “a and b,” “a and c,” “b and c,” or “all of a, b, and c.”

A “terminal” described below may be implemented as a computer or a portable terminal that may access a server or other terminals through a network. Here, computers may include, for example, a notebook computer, a desktop computer, a laptop computer, and the like, which are equipped with a web browser, and portable terminals are wireless communication devices that ensure portability and mobility and may include, for example, all kinds of handheld-based wireless communication devices such as a communication-based terminal, a smartphone, and a tablet personal computer (PC) which support International Mobile Telecommunications (IMT), code division multiple access (CDMA), W-code division multiple access (W-CDMA), Long Term Evolution (LTE), etc.

Hereinafter, the example embodiments of the present disclosure will be described in detail with reference to the accompanying drawings so that those skilled in the art to which the present disclosure pertains may easily practice the present disclosure. However, the present disclosure may be implemented in various different forms and is not limited to the example embodiments described herein.

Hereinafter, the example embodiments of the present disclosure will be described in detail with reference to the accompanying drawings.

In describing the example embodiments, descriptions of technical contents that are well known in the technical field to which the present disclosure pertains and that are not directly related to the present disclosure will be omitted. This is to more clearly convey the gist of the present disclosure without ambiguity by omitting unnecessary descriptions.

For the same reason, some components in the accompanying drawings are exaggerated, omitted, or schematically illustrated. In addition, the size of each component does not entirely reflect the actual size. The same reference numerals are assigned to the same or corresponding components in each drawing.

Various advantages and features of the present disclosure and methods accomplishing them will become apparent from the following description of the example embodiments with reference to the accompanying drawings. However, the present disclosure is not limited to the example embodiments disclosed herein but may be implemented in various forms. The example embodiments make contents of the present disclosure thorough and are provided so that those skilled in the art can easily understand the scope of the present disclosure. Therefore, the present disclosure will be defined by the scope of the appended claims. Throughout the specification, like reference numerals denote like components.

In this case, it will be appreciated that each block of a processing flowchart and combinations of the flowcharts may be executed by computer program instructions. Since these computer program instructions may be installed in a processor of a general computer, a special purpose computer, or other programmable data processing apparatuses, these computer program instructions executed through the processor of the computer or the other programmable data processing apparatuses create a means for performing functions described in the block(s) of the flowchart. Since these computer program instructions may also be stored in a computer usable or computer readable memory of a computer or other programmable data processing apparatuses in order to implement the functions in a specific scheme, the computer program instructions stored in the computer usable or computer readable memory can also produce manufacturing articles including an instruction means for performing the functions described in the block(s) of the flowchart. Since the computer program instructions may also be installed in the computer or the other programmable data processing apparatuses, the instructions perform a series of operation steps on the computer or the other programmable data processing apparatuses to create processes executed by the computer, thereby running the computer, or the other programmable data processing apparatuses may also provide operations for performing the functions described in the block(s) of the flowchart.

In addition, each block may indicate some modules, segments, or code including one or more executable instructions for executing a specific logical function(s). Further, it is to be noted that functions described in the blocks occur regardless of a sequence in some alternative example embodiments. For example, two blocks that are consecutively shown may in fact be simultaneously performed or performed in a reverse sequence depending on corresponding functions.

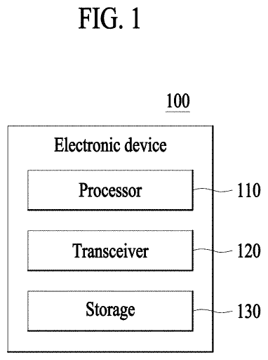

FIG. 1 is a block diagram illustrating components of an electronic device according to various example embodiments of the present disclosure.

Referring to FIG. 1, internal components of an electronic device 100 are not limited only to the illustrated components. The electronic device 100 may include at least one of a processor 110, a transceiver 120, and a storage 130.

The processor 110 may process a series of operations for performing an information processing method according to various example embodiments of the present disclosure. The processor 110 may control components of the electronic device 100.

The transceiver 120 may perform a function of transmitting information stored in the storage 130 of the electronic device 110 or information processed by the processor 100 to other devices or a function of transferring information from other devices to the electronic device 100.

The storage 130 has a data structure implemented in a predetermined storage space of the electronic device 100, and thus, functions such as storing, searching, deleting, editing, or adding data may be freely performed. For example, the storage 130 may include fields or components for processing functions such as storing, searching, deleting, editing, or adding data. The storage 130 may store data related to performing an information providing method by the electronic device 100. For example, the storage 130 may store instructions or data for an execution operation of the processor 110.

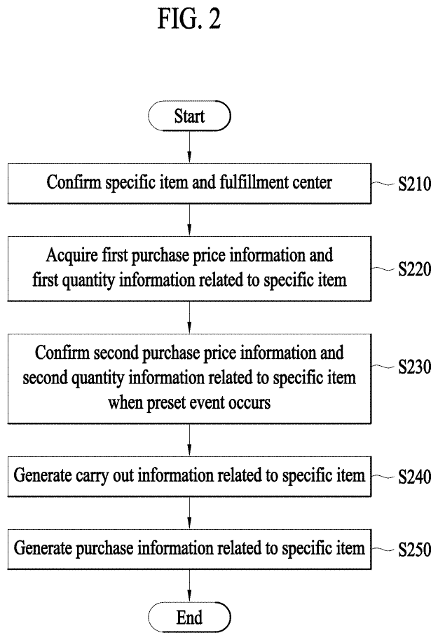

FIG. 2 is a schematic flowchart of an information processing method according to various example embodiments of the present disclosure.

FIG. 2 illustrates a flow of a method of processing information on an item that is managed, relayed, or sold through an electronic device (for example, the electronic device 100 of FIG. 1, a server of a distribution system). For example, the electronic device may process purchase price information related to an item put into a fulfillment center according to contract details through a supplier and purchase quantity information with the corresponding purchase price information, based on purchase information related to the item that is managed, relayed, or sold.

In operation S210, the electronic device may confirm a specific item and the fulfillment center. For example, the electronic device may include a server of a distribution system that manages, relays, or sells an item. According to an example embodiment, the electronic device may confirm a specific item and a fulfillment center based on a user input for operating the server of the system. According to another example embodiment, the electronic device may confirm a specific item and a fulfillment center without a user input in response to a change in at least one of purchase price information, quantity information, and sales price information related to the specific item. The reason why the electronic device may confirm an item and a fulfillment center without a user input is that the processor (for example, the processor 110 of FIG. 1) of the electronic device may be based on machine learning or information on a specific item that is repeatedly learned.

In operation S220, the electronic device may acquire purchase price information and quantity information related to a specific item put into a fulfillment center. For example, in operation S210, the electronic device may acquire purchase price information and quantity information related to the specific item put into the fulfillment center according to a contract with a supplier for the specific item. The electronic device may confirm receipt of a specific item in a fulfillment center based on information on a contract concluded with a supplier to purchase “300 pieces of” a specific item, “sneaker 1” with a purchase price of “50,000 won.” In this case, the electronic device may confirm the information on the specific item put into the fulfillment center. The electronic device may acquire “50,000 won” as purchase price information and “300 pieces” as quantity information related to the “sneaker 1” put into the fulfillment center. The purchase quantity information corresponding to the purchase information (for example, first purchase information) on the specific item contracted with the supplier may be different from the purchase price information (for example, first purchase price information) and the quantity information (for example, first purchase price information) put into the fulfillment center. The purchase quantity information according to the purchase contract may be confirmed as “300 pieces,” and the quantity information for a specific item put into the fulfillment center may be confirmed as “200 pieces”. As a case where the purchase quantity information and the first quantity information may be different as described above, there may be a missing count for a quantity of a specific item. As another example, the electronic device may acquire quantity information for each piece of purchase price information or purchase price information for each piece of quantity information for a specific item. The electronic device may acquire quantity information of “100 pieces” with purchase price information of “45,000 won” and quantity information of “200 pieces” with purchase price information of “50,000 won” for “sneaker 1”. As such, as the case where the price information and quantity information related to the specific item acquired by the electronic device are different, there may be a case where the same item is provided from a different supplier or the same item is purchased at a different time.

In operation S230, the electronic device may confirm purchase price information (for example, second purchase price information) and quantity information (for example, second quantity information) on a specific item when a preset event occurs. The preset event may occur in response to a change in sales price information related to a specific item or in response to a discrepancy between purchase quantity information corresponding to purchase information (for example, first purchase information) and first quantity information. For example, when sales price information related to a specific item is changed, the electronic device may confirm second purchase price information. As another example, when the discrepancy between the purchase quantity information and the first quantity information related to the specific item is confirmed, the electronic device may confirm the second quantity information from the difference between the purchase quantity information and the first quantity information. When the electronic device confirms that quantity information corresponding to purchase price information of “50,000 won” on “Feb. 10, 2020” when a specific item, “sneaker 1” is put into “fulfillment center 1” is “100 pieces,” and then confirms that the quantity information of “100 pieces” is the missing count for the purchase quantity information of “200 pieces”, the electronic device may confirm that the purchase quantity information for a specific item and the first quantity information are mismatched.

In operation S240, the electronic device may generate carry out information related to a specific item in response to the occurrence of a preset event. The electronic device may generate carry out information related to a specific item based on first purchase price information and first quantity information related to the specific item. The carry out information is not actually information about carrying out a specific item from a fulfillment center to a supplier. The electronic device may confirm that sales price information related to a specific item has changed, and then change a purchase contract for a specific item by adjusting the purchase contract with a supplier. For example, in purchase information for purchasing a specific item from a supplier for “1,000 won” and the specific item is sold for “1,100 won,” when the specific item is sold for “1,000 won”, the electronic device may change purchase information in response to a change in sales price information and purchase the specific item from the supplier for “900 won”. In order to reduce errors that may occur in the process of redundantly issuing a VAT invoice with a supplier, the electronic device may generate information for virtually carrying out a specific item, not information for actually carrying out the specific item. For example, the electronic device may purchase “100 pieces” of a specific item for “1,000 won” and put the purchased specific item into the fulfillment center, but may confirm that the purchase information changes to purchasing “100 pieces” of a specific item for “900 won”. In this case, the electronic device may leave a VAT invoice (for example, first VAT invoice) for “1,000 won” and “100 pieces” already generated as it is, and then generate a virtual VAT invoice (for example, first virtual VAT invoice) that carries out “100 pieces” of a specific item for “1000 won” to a supplier.

In operation S250, the electronic device may generate purchase information related to a specific item. The electronic device may generate information (for example, second purchase information) that purchases “100 pieces of a specific item for “900 won” from a supplier in the example in operation S240. The second purchase information may be generated based on the second purchase price information and the second quantity information. The electronic device may generate a virtual VAT invoice (for example, second virtual VAT invoice) that purchases “100 pieces” of a specific item for “900 won” from a supplier. In this case, the electronic device may generate the first VAT invoice for “1,000 won” and “100 pieces” generated by the first purchase information, the first virtual VAT invoice for “1,000 won” and “100 pieces”, and the second virtual VAT invoice for “900 won” and “100 pieces”. The electronic device may generate a final VAT invoice by summing the first VAT invoice, the first virtual VAT invoice, and the second virtual VAT invoice.

As another example, the electronic device may confirm the purchase quantity information, which should be put into the fulfillment center, as “200 pieces” based on the purchase information (for example, first purchase information) with the supplier, and confirm the quantity information (for example, first quantity information) on the specific item counted as put into the fulfillment center as “100 pieces”. The electronic device may generate a virtual VAT invoice for additional purchase of “100 pieces” to generate a virtual VAT invoice for “100 pieces” and then generate a VAT invoice for “200 pieces”.

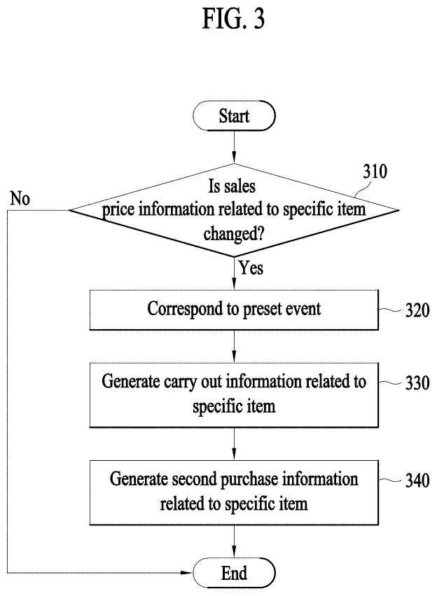

FIG. 3 is a flowchart illustrating whether a preset event corresponding to a specific item occurs according to various example embodiments of the present disclosure.

Referring to FIG. 3, the electronic device (for example, the electronic device 100 of FIG. 1) may confirm whether sales price information set based on first purchase information related to a specific item has changed, and the changed sales price information may generate second purchase information for purchasing a specific item by making a new contract with a supplier according to the changed sales price information.

In operation 310, the electronic device may confirm the change in the sales price information related to a specific item. When the sales price information related to the specific item is changed, since the specific item corresponds to the occurrence of the preset event, the electronic device may perform operations after operation 320.

In operation S330, the electronic device may generate virtual information related to a specific item. For example, the electronic device may generate carry out information based on “50,000 won” corresponding to the quantity information of “300 pieces” for “sneaker 1”. When the electronic device confirms that sales price information related to “sneaker 1” has changed from “55,000 won” to “50,000 won”, carry out information related to “300 pieces” of “sneaker 1” purchased at a purchase price of “50,000 won” may be generated.

In operation S340, the electronic device may generate second purchase information related to a specific item. For example, the electronic device may generate purchase information related to “300 pieces” of “sneaker 1” for “45,000 won” in response to a change in sales price information (for example, second purchase information) on “sneaker 1”.

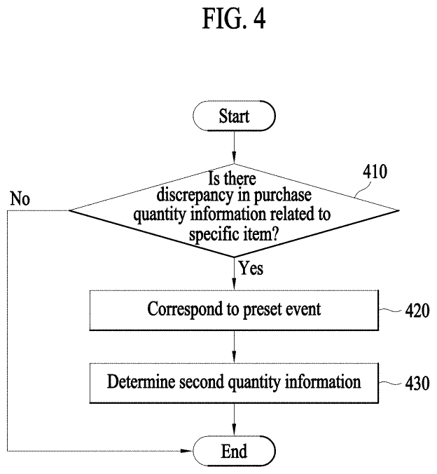

FIG. 4 is a flowchart illustrating whether the preset event corresponds to the specific item according to various example embodiments of the present disclosure.

Referring to FIG. 4, the electronic device (for example, the electronic device 100 of FIG. 1) may confirm a discrepancy in purchase quantity information related to a specific item. When a discrepancy between the purchase quantity information and the first quantity information related to the specific item is confirmed, the electronic device may confirm the second quantity information from the difference between the purchase quantity information and the first quantity information.

In operation 410, the electronic device may confirm a discrepancy between purchase quantity information corresponding to purchase information (for example, first purchase information) on a specific item and quantity information related to a specific item that is warehoused from a supplier and counted in a fulfillment center. When it is confirmed that there is a discrepancy in the purchase quantity information related to the specific item, since the specific item corresponds to the occurrence of the preset event, the electronic device may perform operations after operation 420.

In operation S430, the electronic device may determine second purchase information related to a specific item. For example, virtual carry out information may be provided based on purchase price information. The electronic device may confirm the purchase quantity information, which should be put into the fulfillment center, as “200 pieces” based on the purchase information (for example, first purchase information) with the supplier, and confirm the quantity information (for example, first quantity information) on the specific item counted as put into the fulfillment center as “100 pieces”. The electronic device may generate a virtual VAT invoice for additional purchase of a quantity (for example, second quantity information) of “100 pieces” to generate the virtual VAT invoice for “100 pieces” and then generate the VAT invoice for “200 pieces”. When the first purchase price information and the second purchase price information are the same, the electronic device may generate second purchase information including second quantity information, which is a quantity smaller than the first purchase price information. The electronic device may confirm the second quantity information from the difference between the purchase quantity information and the first quantity information.

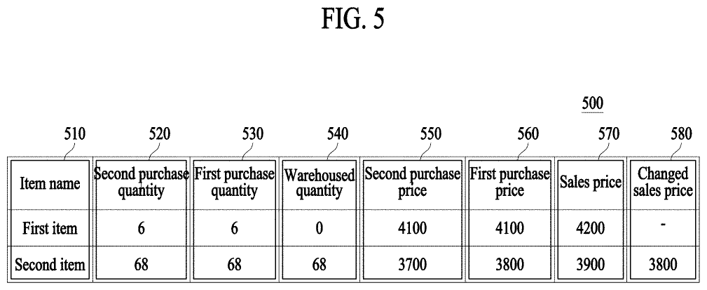

FIG. 5 is an exemplary diagram of information on a specific item managed by an information processing method according to various example embodiments of the present disclosure.

Referring to FIG. 5, the electronic device (for example, the electronic device 100 of FIG. 1) may generate a VAT invoice based on purchase information with a supplier for a specific item 510. The VAT invoice may be generated based on purchase price information and quantity information related to the specific item 510, and a method of generating a virtual VAT invoice in the middle to prevent errors that may occur during a generation process may be used. An information processing method of an item in a distribution system described in this specification is to prevent errors when generating a VAT invoice.

According to various example embodiments, the electronic device may manage information on the specific item 510 in a table format as illustrated in FIG. 5. For example, the electronic device may confirm information on the specific item 510 put into “fulfillment center 1”. Referring to FIG. 5, the specific item 510 is illustrated as a first item and a second item but is not limited thereto. In the description of FIG. 5, purchase price information (for example, second purchase price information 550 and first purchase price information 560) is described based on the fact that the purchase price information corresponds to purchase quantity information (for example, second purchase quantity information 520 and first purchase quantity information 530) on the specific item 510. For example, the “first item” relates to purchasing “6 pieces” at a price of “4,100 won”, but the quantity of items that are counted as actually put into a fulfillment center is “0 pieces”. Thereafter, a virtual VAT invoice may be generated in response to purchase information (for example, second purchase information) for purchasing “6 pieces” at a price of “4,100 won” to prevent errors when a VAT invoice is issued. In the description of FIG. 5, changed sales price information 580 is described based on the case where the sales price for the specific item 510 is changed after the first purchase information.

The electronic device may confirm the second purchase quantity information 520, the first purchase quantity information 530, warehousing quantity information 540 (for example, first quantity information), the second purchase price information 550, the first purchase price information 560, the sales price information 570, and the changed sales price information 580. For example, the electronic device may purchase “6 pieces” for the “first item” put into the “fulfillment center 1”, confirm that “0 pieces” have been counted as warehoused, and generate purchase information for purchasing “6 pieces” again at a price of “4,100 won”.

The electronic device may provide ordering information by confirming a discrepancy in the quantity information related to the specific item 510. For example, when the electronic device confirms that the quantity information corresponding to the “first item” put and counted in the fulfillment center is “0 pieces”, and then confirms that the quantity information “0 pieces” is an error for “6 pieces”, which is the quantity information to be put into the fulfillment center, based on the purchase information through the contract with the supplier, the electronic device may confirm that the “first item” corresponds to the occurrence of the preset event. The electronic device may generate ordering information with the quantity information related to the “first item” being “6 pieces”

Referring to FIG. 5, the carry out information related to the “second item” may include information on “68 pieces” purchased for “3,800 won”. The purchase information related to the “second item” may include information (for example, second purchase information) for purchasing “68 pieces” of “second item” for “3,700 won.”

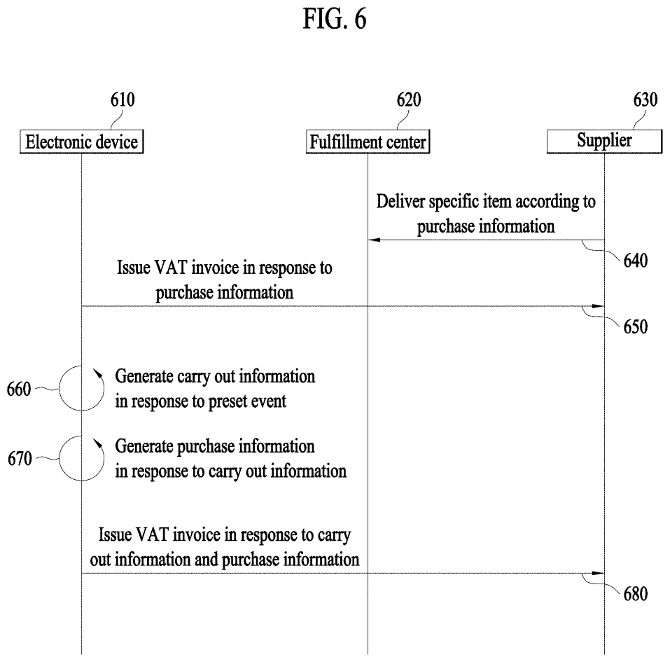

FIG. 6 is a flowchart related to information processing of an electronic device that performs an information processing method according to various example embodiments of the present disclosure.

Referring to FIG. 6, an electronic device 610 (for example, the electronic device 100 of FIG. 1) may generate and issue a VAT invoice to a fulfillment center 620 and a supplier 630 (for example, a server of a supplier).

In operation 640, the supplier 630 delivers a specific item to the fulfillment center 620 in response to purchase information (for example, first purchase information) for delivery of the specific item to the fulfillment center 620 included in the distribution system. The purchase information may include purchase price information and purchase quantity information. The purchase quantity information may be different from quantity information (for example, first quantity information) counted as put into the fulfillment center 620, and in this case, the electronic device 610 may generate carry out information and purchase information (for example, second purchase quantity information).

In operation 650, the electronic device 610 may issue a VAT invoice in response to the purchase information. Issuing the VAT invoice in operation 650 may include issuing a VAT invoice according to a contract with the supplier 630.

In operation S660, the electronic device may generate the carry out information in response to the occurrence of a preset event. The carry out information related to the specific item may include a process of simply processing a VAT invoice for a specific item when the specific item is not actually carried out and the specific item corresponds to the occurrence of the preset event due to a change in purchase price information due to a change in sales price information related to the specific item or a discrepancy between the purchase quantity information and the first quantity information. For example, when the purchase information with the supplier 630 for purchasing “100 pieces” of “sneaker 1” for “50,000 won” has been changed and it is decided to purchase “100 pieces” for “45,000 won”, the electronic device 610 may generate the carry out information related to the sneaker 1” by confirming the “100 pieces” of “sneaker 1” purchased at “50,000 won.” In response to this, the electronic device 610 may generate the purchase information (for example, second purchase information) by confirming that “100 pieces” of “sneaker 1” is purchased at “45,000 won”.

In operation 670, the electronic device 610 may generate the purchase information (for example, second purchase information) according to the carry out information. The second purchase information related to the specific item may include a process of simply processing a VAT invoice for a specific item when the specific item is not actually warehoused and corresponds to a preset event.

In operation 680, the electronic device 610 may generate and issue a VAT invoice to the supplier 630 in response to the carry out information and purchase information related to the specific item. For example, the electronic device 610 may issue a final VAT invoice in response to the first purchase information, the carry out information, and the second purchase information related to the specific item.

According to various example embodiments, the electronic device 610 may confirm display information related to a specific item in the fulfillment center 620 corresponding to the first purchase information. For example, in operation 640, the electronic device 610 may confirm the display information related to the specific item that has been warehoused from the supplier 630 and counted in the fulfillment center 620. The display information may include counted quantity information (for example, first quantity information), and may include information related to a specific item that should have been actually put into the fulfillment center 620 according to the first purchase information. The electronic device 610 may apply the display information based on the first purchase information to a specific item corresponding to the second purchase information.

According to various example embodiments, the purchase quantity information corresponding to the first purchase information may be larger than the first quantity information, which is quantity information related to a specific item that has been put and counted in the fulfillment center 620. The purchase quantity information may correspond to the quantity information contracted by the supplier 630 contracted with a business entity operating the distribution system. The first quantity information may correspond to the quantity information actually counted in the fulfillment center 620 although the purchase quantity information has been delivered.

According to various example embodiments, the electronic device 610 may set identification information related to a specific item corresponding to carry out information related to a specific item as identification information related to a specific item corresponding to the second purchase information. For example, in operations 660 and 670, the electronic device 610 may set identification information related to a specific item as identification information related to a specific item corresponding to the second purchase information. This is to maintain the identity of a specific item, and to maintain the identity of the specific item actually warehoused in operation 640 and the identity of a specific item that is virtually carried out, purchased, and warehoused according to the second purchase information.

According to various example embodiments, purchase identification information corresponding to the first purchase information related to the specific item and purchase identification information corresponding to the second purchase information may correspond to each other. For example, the electronic device 610 may manage purchase history information related to a specific item as predetermined identification information according to the first purchase information and the second purchase information. The electronic device 610 may easily confirm a history of the purchase history information related to the specific item by managing the purchase identification information. The electronic device 610 may confirm the conclusion of an actual purchase and issuance of a VAT invoice for a specific item using the purchase identification information with the first purchase information and the second purchase information.

An information processing method for an item in a distribution system according to various example embodiments of the present disclosure includes confirming a specific item and a fulfillment center based on a user input, acquiring first purchase price information and first quantity information related to the specific item put into the fulfillment center based on first purchase information, confirming second purchase price information and second quantity information related to the specific item when corresponding to the occurrence of a preset event, generating carry out information related to the specific item based on the first purchase price information and the first quantity information; and generating second purchase information related to the specific item based on the second purchase price information and the second quantity information, in which the preset event may occur in response to a discrepancy between purchase quantity information corresponding to the first purchase information and the first quantity information, and the second quantity information may be determined by a difference between the purchase quantity information and the first quantity information.

In the information processing method for an item in a distribution system according to various example embodiments of the present disclosure, the preset event may occur in response to a change in sales price information related to the specific item, and the second purchase price information is confirmed based on the sales price information related to the specific item.

The information processing method for an item in a distribution system according to various example embodiments of the present disclosure may further include confirming display information related to the specific item in the fulfillment center corresponding to the first purchase information, in which the display information may be applied to the specific item corresponding to the second purchase information.

The information processing method for an item in a distribution system according to various example embodiments of the present disclosure may further include setting identification information related to the specific item corresponding to the carry out information related to the specific item as identification information related to the specific item corresponding to the second purchase information.

In the information processing method for an item in a distribution system according to various example embodiments of the present disclosure, purchase identification information corresponding to the first purchase information related to the specific item may correspond to purchase identification information corresponding to the second purchase information related to the specific item.

In the information processing method for an item in a distribution system according to various example embodiments of the present disclosure, when the first purchase price information and the second purchase price information are the same, the purchase quantity information may be larger than the second quantity information.

In the information processing method for an item in a distribution system according to various example embodiments of the present disclosure, when the first purchase price information and the second purchase price information are different, the first quantity information and the second quantity information may be the same.

In the information processing method for an item in a distribution system according to various example embodiments of the present disclosure, at least some of the first purchase information, the second purchase information, and the carry out information may be different.

An electronic device of a distribution system according to various example embodiments of the present disclosure includes a processor, in which the processor performs confirming a specific item and a fulfillment center based on a user input, acquiring first purchase price information and first quantity information related to the specific item put into the fulfillment center based on first purchase information, confirming second purchase price information and second quantity information related to the specific item when corresponding to the occurrence of a preset event, generating carry out information related to the specific item based on the first purchase price information and the first quantity information; and generating second purchase information related to the specific item based on the second purchase price information and the second quantity information, the preset event may occur in response to a discrepancy between purchase quantity information corresponding to the first purchase information and the first quantity information, and the second quantity information may be determined by a difference between the purchase quantity information and the first quantity information.

A non-transitory computer-readable storage medium according to various example embodiments of the present disclosure includes a medium configured to store computer-readable instructions to execute an information processing method, in which when the computer-readable instructions are executed by a processor, the processor performs confirming a specific item and a fulfillment center based on a user input, acquiring first purchase price information and first quantity information related to the specific item put into the fulfillment center based on first purchase information, confirming second purchase price information and second quantity information related to the specific item when corresponding to the occurrence of a preset event, generating carry out information related to the specific item based on the first purchase price information and the first quantity information; and generating second purchase information related to the specific item based on the second purchase price information and the second quantity information, the preset event may occur in response to a discrepancy between purchase quantity information corresponding to the first purchase information and the first quantity information, and the second quantity information may be determined by a difference between the purchase quantity information and the first quantity information.

Meanwhile, example embodiments of the present disclosure have been disclosed in the present specification and drawings, and although specific terms are used, these are merely used in a general sense to easily describe the technical content of the present disclosure and to aid in understanding of the present disclosure but are not intended to limit the scope of the present disclosure. It is obvious to those of ordinary skill in the art to which the present disclosure pertains that other modifications based on the technical idea of the present disclosure can be implemented in addition to the example embodiments disclosed herein.

The electronic device or terminal according to the above-described example embodiments may include a processor, a memory that stores and executes program data, a permanent storage such as a disk drive, a communication port for communication with an external apparatus, a touch panel, a key, a user interface device such as a button, and the like. Methods implemented as software modules or algorithms may be stored on a computer-readable recording medium as computer-readable code or program instructions executable on the processor. Here, examples of the computer-readable recording medium may include magnetic storage media (for example, a read-only memory (ROM), a random-access memory (RAM), a floppy disk, a hard disk, etc.), optical reading media (for example, a compact disk (CD)-ROM or a digital versatile disc (DVD)), and the like. The computer-readable recording medium may be distributed in computer systems connected to each other through a network, and as a result, the computer-readable code may be stored and executed in a distributed scheme. The medium may be readable by a computer, stored in a memory, and executed on a processor.

The present example embodiment may be represented by functional block configurations and various processing operations. These functional blocks may be implemented by various numbers of hardware and/or software components that execute specific functions. For example, the example embodiment may employ integrated circuit configurations, such as a memory, processing, logic, and a look-up table, capable of executing various functions by control of one or more microprocessors or other control devices. Similar to executing the components in software programming or software elements, the present example embodiment can be implemented with programming or scripting languages such as C, C++, Java, Assembly, and Python including various algorithms implemented by a combination of data structures, processes, routines or other programming configurations. Functional aspects may be implemented with algorithms executed on one or more processors. In addition, the present example embodiment may employ a conventional technology for electronic environment setting, signal processing, and/or data processing, and the like. Terms such as “mechanism,” “element,” “means,” and “configuration” may be used broadly and are not limited to mechanical and physical configurations. The terms may include the meaning of a series of routines of software in connection with a processor or the like.

The above-described example embodiments are merely examples, and other example embodiments may be implemented within the scope of the following claims.

What is claimed is:

1. An information processing method of a distribution system, the information processing method comprising:
confirming a specific item and a fulfillment center based on a user input;
acquiring first purchase price information and first quantity information related to the specific item put into the fulfillment center based on first purchase information;
confirming second purchase price information and second quantity information related to the specific item when a preset event occurs;
generating carry out information related to the specific item based on the first purchase price information and the first quantity information; and
generating second purchase information related to the specific item based on the second purchase price information and the second quantity information,
wherein the preset event occurs in response to a discrepancy between purchase quantity information corresponding to the first purchase information and the first quantity information, and
the second quantity information is determined by a difference between the purchase quantity information and the first quantity information.

2. The information processing method of claim 1, wherein the preset event occurs in response to a change in sales price information related to the specific item, and
the second purchase price information is confirmed based on the sales price information related to the specific item.

3. The information processing method of claim 1, further comprising confirming display information related to the specific item in the fulfillment center corresponding to the first purchase information,
wherein the display information is applied to the specific item corresponding to the second purchase information.

4. The information processing method of claim 1, further comprising setting identification information related to the specific item corresponding to the carry out information related to the specific item as identification information related to the specific item corresponding to the second purchase information.

5. The information processing method of claim 1, wherein purchase identification information corresponding to the first purchase information related to the specific item corresponds to purchase identification information corresponding to the second purchase information related to the specific item.

6. The information processing method of claim 1, wherein, when the first purchase price information and the second purchase price information are the same, the purchase quantity information is larger than the second quantity information.

7. The information processing method of claim 1, wherein, when the first purchase price information and the second purchase price information are different, the first quantity information and the second quantity information are the same.

8. The information processing method of claim 1, wherein the first purchase information, the second purchase information, and the carry out information are at least partially different.

9. An electronic device of a distribution system, the electronic device comprising a processor,
wherein the processor is configured to:
confirm a specific item and a fulfillment center based on a user input;
acquire first purchase price information and first quantity information related to the specific item put into the fulfillment center based on first purchase information;
confirm second purchase price information and second quantity information related to the specific item when a preset event occurs;
generate carry out information related to the specific item based on the first purchase price information and the first quantity information; and
generate second purchase information related to the specific item based on the second purchase price information and the second quantity information,
the preset event occurs in response to a discrepancy between purchase quantity information corresponding to the first purchase information and the first quantity information, and
the second quantity information is determined by a difference between the purchase quantity information and the first quantity information.

10. A non-transitory computer-readable storage medium comprising a medium configured to store computer-readable instructions,
wherein when the computer-readable instructions are executed by a processor, the processor is configured to perform an information processing method comprising:
confirming a specific item and a fulfillment center based on a user input;
acquiring first purchase price information and first quantity information related to the specific item put into the fulfillment center based on first purchase information;
confirming second purchase price information and second quantity information related to the specific item when a preset event occurs,
generating carry out information related to the specific item based on the first purchase price information and the first quantity information; and
generating second purchase information related to the specific item based on the second purchase price information and the second quantity information,
the preset event occurs in response to a discrepancy between purchase quantity information corresponding to the first purchase information and the first quantity information, and
the second quantity information is determined by a difference between the purchase quantity information and the first quantity information.
